(19) United States
(12) Patent Application Publication
(10) Pub. No.: US 2026/0044978 A1
(43) Pub. Date: Feb. 12, 2026

(54) Method and Device for Determining a Glasses Pose of Pair of Smart Glasses by Means of Outside-In Tracking

(71) Applicant: Bayerische Motoren Werke Aktiengesellschaft, Muenchen (DE)

(72) Inventors: Tobias BAUERNFEIND, Muenchen (DE); Wolfgang HABERL, Muenchen (DE); Alan KEIM, Hallbergmoos (DE); Manfred PAULI, Bruckberg (DE)

(21) Appl. No.: 19/102,211

(22) PCT Filed: Sep. 8, 2023
(86) PCT No.: PCT/EP2023/074726

§ 371 Date: Feb. 7, 2025

(30) Foreign Application Priority Data
Sep. 21, 2022 (DE) 10 2022 124 273.0

(51) Int. Cl. G06T 7/70; G06V 10/25; G06V 10/764; G06V 20/59

(52) U.S. Cl. CPC G06T 7/70; G06V 10/25; G06V 10/764; G06V 20/59; G06T 2207/30196; G06T 2207/30268

(57) ABSTRACT

A method for determining a pose of a pair of smart glasses in an interior of a mobile machine includes capturing a camera image of an interior of the mobile machine and determining a relevant glasses type for the pair of smart glasses imaged by evaluating a data-based glasses-type recognition model using the captured camera image. The glasses-type recognition model is trained to assign a camera image to a relevant glasses type of one or more pairs of smart glasses. One of a plurality of data-based pose recognition models is selected depending on the recognized glasses type. The pose recognition models are each trained for one glasses type to determine a glasses pose of the corresponding pair of smart glasses according to the camera image. The glasses pose of the pair of smart glasses of the corresponding glasses type is determined via the selected pose recognition model.

### BACKGROUND AND SUMMARY

The invention relates to smart glasses, in particular for use in mobile machines. The invention further relates to measures for tracking a glasses pose on the basis of a pose recognition system that is external to the glasses.

Smart glasses, also referred to as head-mounted displays, are known, which, by means of a display device, are able to display an image on one or two display surfaces in the field of view of the individual wearing the smart glasses. In the case of so-called augmented-reality smart glasses, the display surfaces can correspond to reflection surfaces, which direct images into the eye of the individual wearing the smart glasses. The viewing openings of the smart glasses are transparent, so that the real environment can be perceived through the smart glasses in the usual way. The display surfaces lie in the viewing openings, so that information to be displayed, such as text, symbols, graphics, video displays and the like, can be displayed in a manner overlying the perception of the environment.

The information is displayed to the individual wearing the smart glasses generally in the form of information objects in a contact analogue manner, i.e., is displayed such that these information objects superimpose a specific assigned object in the real environment or are oriented thereto, or such that the information object to be displayed is displayed in a specific orientation of the smart glasses or of the individual wearing them.

In order to display the information objects correspondingly in a contact analogue manner on the display surfaces of the smart glasses, it is necessary to know the position of the object in the environment and the viewing direction of the user. The viewing direction of the user, when the smart glasses are being worn, is fixedly assigned to their pose, i.e., the 3D position as well as the 3D orientation of the smart glasses.

The glasses pose of the smart glasses can be determined by an external pose recognition device, in which an interior camera is directed towards the head of the individual wearing the smart glasses and the towards the smart glasses and the glasses pose of the smart glasses is determined by evaluating the camera image. The interior camera is generally an infrared camera so as to allow good capturing of the region of the smart glasses even in poor light conditions. Such a tracking method is referred to as outside-in tracking and is generally based on a data-based pose recognition model, which is also configured as a data-based pattern or object recognition model.

The pose recognition model can be designed as an artificial neural network or the like and can be trained to assign one or more camera images, in which a pair of smart glasses is displayed, to a glasses pose by means of a pattern recognition method. The glasses pose has a reference to a vehicle coordinate system, which serves as a reference system. This glasses pose is then transmitted to the smart glasses, so that a contact analogue display of an information object can be made. In this regard, the glasses pose provided externally of the glasses is often improved with the aid of a sensor data fusion with information captured by motion sensors within the glasses, in order to provide glasses pose information in the smart glasses latency-free to the greatest possible extent.

To recognize the glasses pose of smart glasses from camera images, the data-based pose recognition model can be trained to determine the glasses pose from a camera image in which a pair of smart glasses worn on the head of a user is imaged. Pose recognition models of this kind are trained with training data sets which image the reality to the best possible extent. Smart glasses for use in a vehicle, however, are offered by various manufacturers and have individual, slightly different shapes, which are evident in different shapes of the smart glasses, of the frame, the color of the frame and the like. This requires pose recognition models, which are based on a pattern recognition on the basis of the camera image, to recognize the different embodiments of the smart glasses in order to reliably determine a glasses pose. To this end, the different smart glasses shapes of various manufacturers must be taken into consideration already during the training of the pose recognition model.

Therefore, a pose recognition model must be trained with the different glasses shapes of the various manufacturers in order to enable reliable pose determination.

It is an object of the present invention to provide an improved method for determining a glasses pose on the basis of a pose recognition model, which is easy to train and has a reduced complexity.

At least this object is achieved by the method for determining a glasses pose of a pair of smart glasses in a mobile machine by means of a data-based model system as described herein. At least this object is also achieved by the method for training a model system with a glasses-type recognition model for the individual glasses-type recognition of a pair of smart glasses and a plurality of pose recognition models for a pose determination of the smart glasses as described herein.

According to at least one embodiment, a method for determining a pose of at least one pair of smart glasses in an interior of a mobile machine is provided, comprising the following steps: capturing a camera image of an interior of the mobile machine, in particular by means of an interior camera; evaluating a data-based glasses-type recognition model on the basis of the captured camera image in order to determine a relevant glasses type for at least one pair of smart glasses imaged in the camera image, wherein the data-based glasses-type recognition model is trained to assign a camera image to a relevant glasses type of one or more pairs of smart glasses; selecting, in each case, one of a plurality of data-based pose recognition models depending on the recognized glasses type, wherein the data-based pose recognition models are each trained for one glasses type, in order to determine a glasses pose of the corresponding pair of smart glasses according to the camera image; determining, in each case, the glasses pose of the pair of smart glasses of the corresponding glasses type by means of the selected pose recognition model.

In at least one embodiment, a model system determines a glasses pose of a pair of smart glasses in an interior of a mobile machine by means of an interior camera external to the glasses. For this purpose, the model system comprises a glasses-type recognition model that first searches the camera image for smart glasses located in it and assigns a glasses type depending on a shape and/or other characteristic of a recognized pair of smart glasses. The glasses-type recognition model therefore only needs to be trained to recognize smart glasses of a certain glasses type and assign them to the recognized glasses type. Depending on the recognized glasses type, a corresponding pose recognition model can be selected from a large number of data-based pose recognition models assigned to a specific glasses type and then used to determine a glasses pose of the displayed smart glasses.

The data-based pose recognition model is trained precisely for the specific glasses type and therefore does not take into account other glasses types or glasses shapes. Since only one glasses type, i.e., a specific shape of the smart glasses, needs to be taken into account for training the data-based pose recognition model, this corresponding pose recognition model can be simpler and less complex in its structure and requires a correspondingly smaller number of training data sets for training, which only take into account poses of the specific glasses type. The implementation for evaluating such a pose recognition model is also less complex.

According to a further embodiment, a bounding box of the recognized smart glasses can be determined simultaneously with the glasses-type recognition by means of the glasses-type recognition model, wherein the relevant pose recognition model is applied to a detail of the camera image that is determined by the bounding box.

Thus, the glasses type recognition model can determine a bounding box and thus enable a search space restriction, so that the pose recognition model is selected by specifying the glasses type and can then perform pose recognition in a simpler way in a corresponding detail of the captured camera image by specifying the search frame.

It may be provided that the pose of the at least one pair of smart glasses is transmitted to the relevant smart glasses so that a contact analogue display can be displayed in the relevant smart glasses depending on the pose of the glasses.

Furthermore, model parameters of the selected pose recognition model can be retrieved from a database and implemented in order to provide the corresponding pose recognition model. The database can be located in a cloud, i.e., outside the mobile machine.

In at least one embodiment, a device for determining the pose of at least one pair of smart glasses in an interior of a mobile machine comprises: an interior camera, which is designed to capture a camera image of an interior of the mobile machine; a processor unit, which is configured:
in order to evaluate a data-based glasses-type recognition model on the basis of the captured camera image, to determine a relevant glasses type for at least one pair of smart glasses imaged in the camera image, wherein the data-based glasses-type recognition model is trained to assign a camera image to a relevant glasses type of one or more pairs of smart glasses;
to select, in each case, one of a plurality of data-based pose recognition models depending on the recognized glasses type, wherein the data-based pose recognition models are each trained for a specific glasses type, in order to determine a glasses pose of the corresponding pair of smart glasses according to the camera image; and
to determine, in each case, the glasses pose of the pair of smart glasses of the corresponding glasses type by means of the selected pose recognition model.

Furthermore, a communications unit can be designed to transmit the glasses pose to the smart glasses.

One or more embodiments, features and/or aspects are explained in greater detail below with reference to the accompanying drawings.

### BRIEF DESCRIPTION OF THE DRAWINGS

FIG. 1 shows a display system with a pair of smart glasses for use in a vehicle;

FIG. 2 shows a flowchart for illustrating a method for pose recognition of a pair of smart glasses in a vehicle interior; and

FIG. 3 shows various glasses shapes of smart glasses.

### DETAILED DESCRIPTION OF THE DRAWINGS

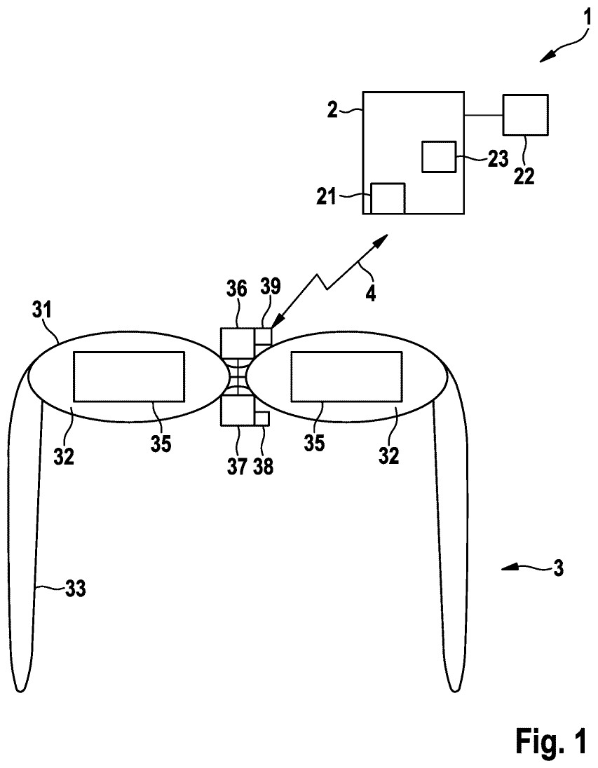

FIG. 1 shows a schematic representation of a display system 1, in particular for use in a motor vehicle. The display system 1 comprises an assistance system 2, which is communicatively connected 4 to a pair of smart glasses 3. The communications link 4 is designed as a data transmission channel, e.g., in the form of a wireless communications link or a wired communications link. The communications link 4 is capable of transmitting any type of data and information between the assistance system 2 and the smart glasses 3, for example on the basis of packet-based data transmission. The communications link 4 can be based on WiFi, Bluetooth, Bluetooth Low Energy or a comparable standardized radio protocol, for example.

The assistance system 2 can be part of a vehicle assistance system and, in particular, can be provided in a fixed position in the motor vehicle. The assistance system 2 can be equipped with a communications unit 21, which enables the communications link 4 between the smart glasses 3 and the assistance system 2.

The assistance system 2 may further be provided with an interior camera 22 as a camera directed towards the smart glasses 3, which is directed towards a probable area of a head of a user/wearer of the smart glasses 3. The interior camera 22 may comprise, for example, an RGB camera or an infrared camera.

The assistance system 2 can have a processor unit 23. The processor unit 23 can implement a data-based model system, which is described in greater detail below. The model system comprises a glasses-type recognition model and a plurality of pose recognition models, each of which is trained to determine a glasses pose on the basis of a camera image from the interior camera 22. The glasses pose is then transmitted to the smart glasses 3 via the communications unit 21.

For display in the smart glasses 3, object information is generated which specifies the object position, object content and object type of the display of the at least one virtual display object in the smart glasses 3.

The pair of smart glasses 3 comprises two transparent lenses 32, which are enclosed in a frame 31 in a manner known per se. The frame 31 is provided with glasses temples 33, so that the smart glasses 3 can be worn on the head of a user in a manner known per se.

One or both lenses 32 (glasses lenses) are further provided with a transparent display surface 35, through which a display image for displaying virtual display objects can be projected into the eye of the individual wearing the smart glasses 3 by a suitable device, such as a display device 36 arranged on the frame 31. The display device 36 may comprise a microprocessor or a comparable computing unit and a display unit, such as a projection device or the like. The display unit can be designed to direct the electronically generated display image onto the display surface 35 and to image/display it there.

Due to the transparent design of the display surface 35, the electronically generated image can be superimposed (augmented) on the real environment perceptible through the display surface 35. By means of the display device 36, a virtual display object, such as a text, a symbol, video information, a graphic or the like, can be displayed on one or both display surfaces 35. The object information defines the object position and display of the at least one virtual display object in relation to the motor vehicle, i.e., in the vehicle coordinate system (reference system of the motor vehicle).

Furthermore, the smart glasses 3 can be provided with a control unit 37. The control unit 37 can be designed separately or together with the microprocessor of the display device 36. The control unit 37 can be suitably designed to execute or support smart glasses functions and functions of the display system 1. For this purpose, the assistance system 2 can be connected to the smart glasses 3 in order to transmit to the smart glasses 3 the object information relating to virtual display objects to be displayed in a contact analogue or non-contact-analogue manner and the glasses pose determined externally in relation to the vehicle coordinate system. For this purpose, the smart glasses 3 can comprise a communications unit 39 which enables communication with the assistance system 2, in particular in order to detect a glasses pose determined externally to the glasses.

For example, the control unit 37 can read out movement information by means of a glasses inertial sensor system 38. The movement information can be used to correct by sensor fusion the latency-related information of the glasses pose determined externally of the glasses and to provide a corrected glasses pose in the smart glasses 3. This can then be used for the contact-analog display of information objects.

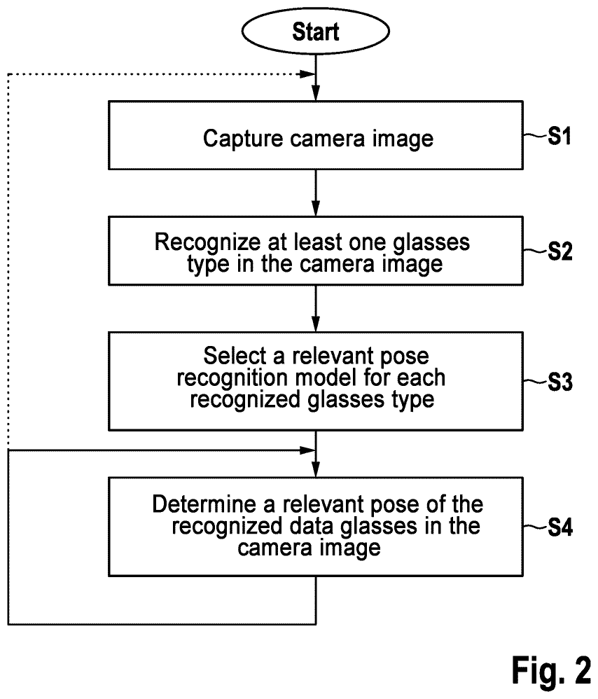

FIG. 2 uses a flow chart to schematically illustrate a method for recognizing the pose of smart glasses 3 in a vehicle as a mobile machine. The pose recognition is carried out remotely from the glasses and in particular in the assistance system 2. The model system consisting of the glasses-type recognition model and a large number of pose recognition models assigned to each glasses type is stored in the form of model parameters in a database of the assistance system 2.

The method initially provides for capturing a camera image in step S1 by means of the interior camera 22.

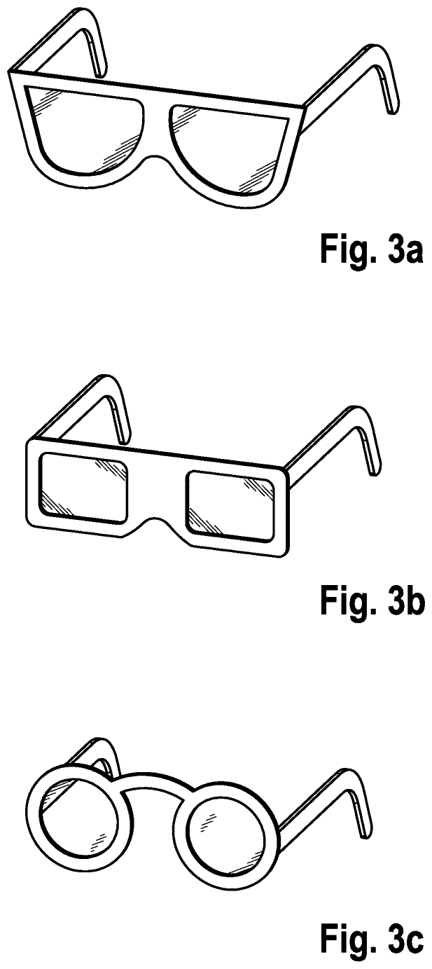

In step S2, this camera image is checked or searched for one or more smart glasses. With the aid of an image recognition method or pattern recognition method in the form of the data-based glasses-type recognition model, a glasses type of at least one pair of smart glasses can be recognized in the camera image on the basis of predefined glasses shapes of smart glasses, such as those shown in FIGS. 3a to 3c. By means of the implemented pattern recognition method, the glasses type of the at least one pair of smart glasses 3 worn by one or more users in the vehicle can thus be classified in the camera image.

The glasses-type recognition model can be designed as an artificial neural network, in particular as a convolutional neural network (CNN), in order to recognize the glasses type based on the shape of the glasses or the characteristics of the smart glasses 3.

In addition, the glasses-type recognition model can be used to recognize a corresponding position in the interior of the vehicle where the relevant smart glasses 3 are located, e.g., in the form of a bounding box surrounding the recognized smart glasses. This makes it possible to provide an indication of the at least one position of the at least one pair of smart glasses 3.

In a subsequent step S3, depending on the glasses type detected, a pose recognition model trained for precisely this glasses type is selected from a large number of pose recognition models assigned to a particular glasses type. The pose recognition model is also data-based and makes it possible to determine a pose of the smart glasses 3 of the specific glasses type in the interior of the vehicle using one or more camera images. The pose of the smart glasses 3 is specified in relation to a vehicle coordinate system.

In step S4, a pose of the smart glasses 3 can be determined using the selected pose recognition model on the basis of the camera image in a manner known per se.

By specifying the bounding box for the specific smart glasses of the corresponding glasses type, the selected pose recognition model can perform pose recognition more reliably and quickly, as the search area in the camera image can be restricted to the bounding box.

The previously selected pose recognition model can now be used continuously to determine the glasses pose.

It can be provided that the glasses type is only determined when smart glasses are recognized in the camera image for the first time. Alternatively, the glasses type can be detected regularly so that a correspondingly different pose recognition model can be selected immediately in the event of a change. In particular, the glasses type can be determined if the pose recognition model has been unable to determine the pose of the smart glasses 3 for a predetermined period of time, e.g., 5 seconds.

### LIST OF REFERENCE SIGNS

1 display system
2 assistance system
3 smart glasses
4 communications link
21 communications unit
22 interior camera
23 processor unit
31 frame
32 lenses
33 glasses temple
35 display surface
36 display device
37 control unit
38 glasses inertial sensor system
39 communications unit

1-7. (canceled)

8. A method for determining a pose of at least one pair of smart glasses in an interior of a mobile machine, comprising:
capturing a camera image of an interior of the mobile machine;
determining a relevant glasses type for at least one pair of smart glasses imaged in the camera image by evaluating a data-based glasses-type recognition model on the basis of the captured camera image, wherein the data-based glasses-type recognition model is trained to assign a camera image to a relevant glasses type of one or more pairs of smart glasses;
selecting, in each case, one of a plurality of data-based pose recognition models depending on the recognized glasses type, wherein the data-based pose recognition models are each trained for one glasses type, in order to determine a glasses pose of the corresponding pair of smart glasses according to the camera image;
determining, in each case, the glasses pose of the pair of smart glasses of the corresponding glasses type by means of the selected pose recognition model.

9. The method of claim 8, wherein a bounding box of the recognized smart glasses is furthermore determined by means of the glasses-type recognition model, wherein the relevant pose recognition model is applied to a detail of the camera image that is determined by the bounding box.

10. The method of claim 8, wherein the pose of the at least one pair of smart glasses is transmitted to the relevant smart glasses so that a contact analogue display can be displayed in the relevant smart glasses depending on the pose of the glasses.

11. The method of claim 8, wherein model parameters of the selected pose recognition model are retrieved from a database and implemented in order to provide the corresponding pose recognition model.

12. The method of claim 8, wherein the model parameters of the pose recognition model are retrieved from a cloud database depending on a recognized glasses type.

13. A device for determining the pose of at least one pair of smart glasses in an interior of a mobile machine, comprising:
an interior camera, which is designed to capture a camera image of an interior of the mobile machine;
a processor unit configured to:
determine a relevant glasses type for at least one pair of smart glasses imaged in the camera image via evaluating a data-based glasses-type recognition model on the basis of the captured camera image, wherein the data-based glasses-type recognition model is trained to assign a camera image to a relevant glasses type of one or more pairs of smart glasses,
select, in each case, one of a plurality of data-based pose recognition models depending on the recognized glasses type, wherein the data-based pose recognition models are each trained for a specific glasses type, in order to determine a glasses pose of the corresponding pair of smart glasses according to the camera image, and
determine, in each case, the glasses pose of the pair of smart glasses of the corresponding glasses type by means of the selected pose recognition model.

14. The device of claim 13, wherein a communications unit is configured to transmit the glasses pose to the smart glasses.
